(19) United States
(12) Patent Application Publication
(10) Pub. No.: US 2025/0109042 A1
(43) Pub. Date: Apr. 3, 2025

(54) PROCESS FOR THE PURIFICATION OF RUTHENIUM WITH RESPECT TO TECHNETIUM AND METAL IMPURITIES IN AN AQUEOUS NITRIC ACID SOLUTION

(71) Applicants: COMMISSARIAT A L'ENERGIE ATOMIQUE ET AUX ENERGIES ALTERNATIVES, PARIS (FR); ORANO, Châtillon (FR)

(72) Inventors: Eugen ANDREIADIS, AVIGNON (FR); Ella MOREAU, BRENS (FR)

(21) Appl. No.: 18/845,044

(22) PCT Filed: Feb. 24, 2023
(86) PCT No.: PCT/FR2023/050266

§ 371 Date: Sep. 9, 2024

(30) Foreign Application Priority Data
Mar. 10, 2022 (FR) F2202100

(51) Int. Cl. C01G 55/00

(52) U.S. Cl. CPC C01G 55/001; C01P 2006/80

(57) ABSTRACT

A process for purifying ruthenium from an aqueous nitric acid solution which is present together with technetium and metal impurities, at a concentration at least 10 times lower than that of the technetium. A process for producing ruthenium-97 from a technetium-99 target which has been proton-irradiated beforehand, including implementation of the purification process. The processes herein can be used for production of ruthenium-97-based radiopharmaceuticals used in nuclear medicine for the diagnosis of cancer by imaging and the treatment thereof by targeted radiotherapy.

### TECHNICAL FIELD

The invention relates to the field of separation and purification of metal elements in solution.

More specifically, the invention relates to a process for purifying ruthenium from an aqueous solution of nitric acid in which it is present together with technetium and metal impurities, at a concentration at least 10 times lower than that of technetium.

It also relates to a process for producing ruthenium-97 from a technetium-99 target having been irradiated with protons, which comprises the implementation of this purification process.

In particular, the invention finds application in the manufacture of ruthenium-97 based radiopharmaceuticals, useful in nuclear medicine for the diagnosis of cancers by imaging and treatment thereof by targeted radiotherapy.

### PRIOR ART

Ruthenium-97 is a radioactive isotope of ruthenium, the half-life of which is 2.9 days and which has been for several years the subject of promising research in the treatment by targeted radiotherapy, also so-called vectorised radiotherapy, of some small-size tumours such as peritoneal carcinosis of ovarian or colorectal origin. Other possible applications would lead to metastatic or residual disease in other pathological situations.

Ruthenium-97 also forms part of the radioisotopes that have proven to be of interest in medical imaging, in particular for carrying out examinations by single-photon emission computed tomography (or SPECT).

In both cases, the use of ruthenium-97 may imply it being administered to the patient in the form of a radiopharmaceutical, i.e. of a product in which it is bound to a vector, i.e. a molecule capable of very specifically targeting the cancer cells to be destroyed (in the case of targeted radiotherapy) or detected (in the case of medical imaging), such as an antibody.

To do so, ruthenium-97 should satisfy radiological purity requirements, which should ideally be higher than 99.00%.

Ruthenium-97 is usually produced by bombarding a natural molybdenum target (which contains molybdenum-95) with α particles, but the yield is low, in particular because of the low abundance of ⁹⁵Mo in natural molybdenum, and the reaction is accompanied by the formation du ¹⁰³Ru, a long-life isotope detrimental to medical applications.

Ruthenium-97 may also be produced by irradiation of a technetium-99 target with protons and, more specifically, by a nuclear reaction ⁹⁹Tc(p,3n)⁹⁷Ru in the proton energy range of 20 MeV to 100 MeV, as described, for example, by N. G. Zaitseva et al. in Radiochimica Acta 1992, 56, 59-68, hereinafter reference [1], and in Applied Radiation and Isotopes 1996, 47 (2), 145-151, hereinafter reference [2]. This production route is certainly interesting because, besides its yield being much higher than that of the irradiation of a natural molybdenum target, it offers the possibility of valorising technetium-99 likely to be recovered during the treatment of spent nuclear fuels.

In this case, ruthenium-97 is produced together with technetium-97 and molybdenum-97.

To recover ruthenium-97 thus produced, the most commonly used process comprises, after dissolving the irradiated target in concentrated nitric acid and substituting the nitric medium with a sulphuric medium by distillation, oxidizing ruthenium in its ruthenium tetraoxide form, RuO₄, which is volatile. This oxidation is carried out by means of a strong oxidant (such as potassium periodate or ammonium persulphate) and by heat-refluxing. Afterwards, the volatile oxide is recovered by trapping in hydrochloric acid or a mixture of hydrochloric acid and hydrogen peroxide to reduce ruthenium (VIII) into ruthenium (III) (cf. reference [2]).

This process has major limitations, in particular in terms of yield, due to losses of ruthenium by gas leakage in the setup as well as by sorption and reduction of the RuO₄ on the walls of the reactor with formation of ruthenium dioxide, RuO₂. In addition, the reduction of ruthenium (VIII) in the traps is sometimes partial and leads to species having poorly defined degrees of oxidation, which further reduces the recovery yield of ruthenium-97, poses problems of radiological contamination and complicates the step of ruthenium-97 vectorisation necessary for the preparation of the radiopharmaceutical. Finally, phenomena of entrainment of the pertechnetic acid, HTcO₄, during reflux affect the separation of ruthenium with respect to technetium and consequently reduce the separation factor FS_{Ru/Tc—}.

In another technical field, namely the processing of spent nuclear fuels, it has been proposed in the European patent application 0 347 625, hereinafter the reference [3], a process for separating ruthenium from technetium and palladium from an aqueous solution of nitric acid comprising numerous metal elements (Te, Ru, Pd, Zr, Ce, U, Pu, Am, Mo) with a large excess of ruthenium relative to technetium (13 times more).

In this process, diethylthiourea (or DEHT) is added to the aqueous solution to be treated in order to reduce the metal species it contains. The palladium precipitates in the form of Pd(0), which allows separating it by filtration, while ruthenium and technetium form cationic complexes, respectively [Ru(NO)-DETHₓ]^{2+ and 3+} and Tc(IV)O²⁺. Afterwards, ruthenium and technetium are separated from the other metal species by passage of the solution over a cation-exchange resin which selectively retains these two metal elements. Afterwards, technetium is recovered by elution with a solution composed of hydrogen peroxide and nitric acid, allowing oxidising it to technetium (VII). Next, ruthenium is recovered by elution of the resin with a highly concentrated aqueous solution of nitric acid.

In view of the foregoing, the Inventors aimed to provide a process which, while allowing very efficiently purifying ruthenium from an aqueous solution of nitric acid in which it is present together with technetium and metal impurities, at a concentration at least 10 times lower than that of technetium, is free from the limitations of the process described in the reference [2].

In particular, they aimed to provide a process that does not involve any oxidation or reduction reaction, that is simple to implement, that is automatable and that does not require a consumption of solvents in large amounts, including toxic solvents.

### DISCLOSURE OF THE INVENTION

These aims are achieved by the invention, which primarily provides a process for purifying ruthenium from an aqueous solution A1 of nitric acid comprising, in addition to the ruthenium at a concentration C1, technetium at a concentration C2 at least 10 times higher than C1, and metallic impurities, which comprises at least the following successive steps:
a) extracting ruthenium from the aqueous solution by means of a cation-exchange resin which retains ruthenium selectively with respect to the technetium when ruthenium and technetium are in an aqueous solution of nitric acid with a molarity comprised between a first value M1 and a second value M2 higher than M1, this extraction comprising contacting, in a chromatography column, the cation-exchange resin with the aqueous solution A1, the molarity of the aqueous solution A1 being comprised between M1 and M2;
b) washing at least once the cation-exchange resin with an aqueous solution A2 of nitric acid with a molarity comprised between M1 and M2; and
c) eluting ruthenium from the cation-exchange resin with an aqueous solution A3 of nitric or hydrochloric acid with a molarity higher than M2 or an aqueous solution A4 of nitric or hydrochloric acid with a molarity at most equal to M2 and comprising a nitrate or a metal chloride, whereby an aqueous solution A5 containing ruthenium is obtained.

In the context of the present invention, a decontamination factor of ruthenium is obtained with respect to technetium at least equal to 400, this decontamination factor corresponding to the ratio of the concentration ratio of ruthenium and technetium in the aqueous solution A1 to the concentration ratio of these two elements in the aqueous solution A5.

In the foregoing and next, by metal impurity, it should be understood a metal that is present in the aqueous solution A1 at a concentration at least 20 times lower than the concentration C1 of ruthenium and, consequently, at least 200 times lower than the concentration C2 of technetium.

In the context of the invention, the metal impurities may in particular be molybdenum and rhodium.

Moreover, the term “molarity”, applied to an aqueous solution of an acid such as nitric acid or hydrochloric acid, should be understood in its usual meaning, namely that it denotes the molar concentration of this acid in said aqueous solution.

Furthermore, the expressions “from . . . to . . . ” and “comprised between . . . and . . . ”, applied to a range of concentrations, are equivalent and mean that the bounds of this range are included.

In accordance with the invention, the metal nitrate or chloride present in the aqueous solution A4 may in particular be a nitrate or a chloride of an alkaline-earth metal, a transition metal, a lanthanide or aluminium.

Among these, preference is given to a nitrate or chloride of calcium, magnesium, strontium, zinc, strontium, iron or aluminium, preference being given to a calcium or magnesium nitrate.

As indicated before, in step a), the aqueous solution A1 should have a molarity comprised between M1 and M2 which define the range of molar concentrations of nitric acid for which the cation-exchange resin retains ruthenium selectively with respect to technetium.

The process may also comprise, before step a), an adjustment of the molarity of the aqueous solution A1 in order to bring, where necessary, this molarity to a value comprised between M1 and M2, this adjustment being achievable by:
either diluting the aqueous solution A1, advantageously with very weakly concentrated nitric acid, if this solution has a molar concentration of nitric acid higher than M2;
or adding concentrated nitric acid to the aqueous solution A1 if this solution has a molar concentration of nitric acid lower than M1.

In accordance with the invention, the cation-exchange resin may be any cation-exchange resin which is capable of retaining ruthenium selectively with respect to technetium when brought into contact with an aqueous solution of nitric acid with a molarity comprised between M1 and M2 and in which these two metal elements are present.

In particular, this resin may be a porous organic resin, made of a poly(meth)acrylate or polystyrenic matrix, preferably a polystyrenic matrix, which is crosslinked and functionalised by sulphonic acid groups, —SO₃H.

For example, resins of this type are the resin AG MP-50 from the company BioRad, the resins Dowex 50W-X8, Dowex™ Marathon C-10, Dowex™ HCR-W2, Dowex™ Monosphere™ C-400 from the company Dow, the resins AmberLite™ HPR1200 H, Amberlite™ IRN77 and Amberlite™ IR122 Na from the company DuPont, the resins Purolite™ C100E and Purolite™ C145 from the company Purolite, the resins Diaion™ PK208 and Diaion™ SK1B from the company Mitsubishi Chemical Corporation or still the resin Lewatit™ MonoPlus S 200 KR from the company Lanxess.

Among these, preference is given to the resin AG MP-50 which is formed of a styrene/divinylbenzene copolymer bearing sulphonic acid groups.

These resins retain ruthenium selectively with respect to technetium when they are brought into contact with an aqueous solution of nitric acid comprising these metal elements and the nitric acid concentration of which is between 0.01 mol/L and 0.5 mol/L, a concentration at which the ruthenium would be retained by the resins in the form of nitrated ruthenium-nitrosyl complexes.

In which case, the aqueous solutions A1 and A2 preferably comprise from 0.01 mol/L to 0.5 mol/L and, still better, 0.1 mol/L of nitric acid.

In which case also, step c) aiming to elute ruthenium from the cation-exchange resin is carried out:
either with an aqueous solution A3 which advantageously comprises at least 2 mol/L and, still better, at least 4 mol/L of nitric or hydrochloric acid, for example 6 mol/L of nitric or hydrochloric acid;
or with an aqueous solution A4 which advantageously comprises from 0.01 mol/L to 0.5 mol/L of nitric or hydrochloric acid, for example 0.01 mol/L of nitric or hydrochloric acid, and at least 1 mol/L and, more preferably, at least 2 mol/L of the metal nitrate or chloride.

In accordance with the invention, step b) comprises at least one washing of the cation-exchange resin with an aqueous solution A2 comprising nitric acid like the aqueous solution A1.

This step primarily aims to remove from the cation-exchange resin and, in particular, from its interstitial volume, the technetium that might have been retained by this resin in step a).

Therefore, the washing(s) of step b) is (are) carried out with an aqueous solution A2 of nitric acid, whose molarity, in addition to be comprised between M1 and M2, is preferably lower than or equal to the molarity that the aqueous solution A1 has in step a).

In accordance with the invention, the process may comprise, upon completion of step c), an additional purification of the ruthenium present in the aqueous solution A5 in order to remove, if necessary, metal impurities that may be still present in the aqueous solution A5.

Advantageously, this additional purification is carried out by means of a chelating organic resin.

This resin may primarily be a resin comprising a diglycolamide as a chelating agent, which resin may be a resin impregnated with the diglycolamide or a resin onto which the diglycolamide is grafted.

It should be recalled that the term “diglycolamide” refers to a family of compounds of formula (I) or of formula (II) hereinafter:
R¹(R²)N—C(O)—CH₂—O—CH₂—C(O)—N(R³)R⁴ (I)
R¹(R²)N—C(O)—CH₂—O—CH₂—COOH (II)

wherein R¹, R², R³ and R⁴ are typically linear or branched alkyl groups.

Preferably, the resin comprising the diglycolamide is a resin made of a poly(meth)acrylate or polystyrenic matrix, preferably a polystyrenic matrix, which is crosslinked and impregnated with a lipophilic diglycolamide, i.e. a diglycolamide which comprises at least 24 carbon atoms, such as N,N,N′,N′-tetra-n-octyl-3-oxapentanediamide (or TODGA), N,N,N′,N′-tetra(2-ethylhexyl)-3-oxapentanediamide (or TEHDGA), N,N,N′,N′-tetra-n-decyl-3-oxapentane-diamide (or TDDGA) or N,N,N′,N′-tetra-n-dodecyl-3-oxapentanediamide (or TdDDGA).

In particular, a resin of this type is the resin DGA N (standing for Normal) from the company Triskem, which is formed of a styrene/divinylbenzene copolymer impregnated with TODGA and which is available in the form of particles packaged in flasks but also in form of ready-to-use chromatography columns, or cartridges.

If such a chelating organic resin is used, then the additional purification of ruthenium preferably comprises at least the following successive steps:
d) extracting ruthenium from the aqueous solution A5, this extraction comprising contacting, in a chromatography column, the chelating organic resin with the aqueous solution A5, the aqueous solution A5 comprising at most 4 mol/L of nitric or hydrochloric acid and, possibly, from 0.45 mol/L to 4 mol/L of an amine base;
e) washing at least once the chelating organic resin with an aqueous solution A6 comprising at most 4 mol/L of nitric or hydrochloric acid and, possibly, from 0.45 mol/L to 4 mol/L of the amine base; and
f) eluting ruthenium from the chelating organic resin with an aqueous solution A7 comprising at least 0.01 mol/L of nitric or hydrochloric acid.

Alternatively, the chelating organic resin may also be a resin comprising a bipyridine or a phenanthroline as a chelating agent, which resin may be a resin impregnated with bipyridine or phenanthroline or a resin on which bipyridine or phenanthroline is grafted.

It should be recalled that the term “bipyridine” refers to a family of compounds formed from two pyridines connected to each other by a covalent bond whereas the term “phenanthroline” refers to a family of compounds formed from three condensed aromatic rings, each of the two opposite rings of which contains a nitrogen atom facing one another.

In particular, an organic resin comprising this type of chelating agent may be obtained by impregnating an adsorbent resin, having a crosslinked poly(met)acrylate or polystyrenic matrix, with bipyridine or phenanthroline. For example, an adsorbent resin able to be thus impregnated is the resin Amberlite™ XAD4 from the company DuPont, which consists of a styrene/divinylbenzene copolymer.

In which case:
the bipyridine with which the resin is impregnated may in particular be any lipophilic derivative of 2,2′-bipyridine, such a derivative being typically a 2,2′-bipyridine substituted with one or more hydrocarbon group(s), for example alkyl(s) or phenyl(s), such as 4,4′-dinonyl-2,2′-bipyridine, 4,4′-dimethyl-2,2′-bipyridine, 5,5′-dimethyl-2,2′-bipyridine, 4,4′-di-tert-butyl-2,2′-bipyridine or 4,4′-diphenyl-2,2′-bipyridine; whereas
the phenanthroline with which the resin is impregnated may in particular be any lipophilic derivative of 1,10-phenanthroline, such a derivative typically being a 1,10-phenanthroline substituted with one or more hydrocarbon group(s), for example alkyl(s) or phenyl(s), such as 4-methyl-1,10-phenanthroline, 5-methyl-1,10-phenanthroline, 5,6-dimethyl-1,10-phenanthroline, neocuproin (or 2,9-dimethyl-1,10-phenanthroline), bathocuproin (or 2,9-dimethyl-4,7-diphenyl-1,10-phenanthroline) or bathophenanthroline (or 4,7-diphenyl-1,10-phenanthroline).

Among bipyridines, preference is given to 4,4′-dinonyl-2,2′-bipyridine, whereas, among phenanthrolines, preference is given to bathophenanthroline.

If such a chelating organic resin is used, then the additional purification of ruthenium preferably comprises at least the following successive steps:
d) extracting ruthenium from the aqueous solution A5, this extraction comprising contacting, in a chromatography column, the chelating organic resin with the aqueous solution A5, the aqueous solution A5 comprising at most 4 mol/L of nitric or hydrochloric acid and, possibly, from 0.45 mol/L to 4 mol/L of an amine base;
e) washing at least once the chelating organic resin with an aqueous solution A6 comprising at most 4 mol/L of nitric or hydrochloric acid and, possibly, from 0.45 mol/L to 4 mol/L of the amine base; and
f) eluting ruthenium from the chelating organic resin with an aqueous solution A7 comprising at least 0.01 mol/L of nitric or hydrochloric acid.

Still alternatively, the chelating organic resin may also be a resin comprising a thiourea as a chelating agent, which resin may be, herein again, a resin impregnated with thiourea or a resin on which thiourea is grafted.

It should be recalled that the term “thiourea” refers to a family of compounds of formula: (R¹R²N)(R³R⁴N)C═S wherein R¹, R², R³ and R⁴ are typically hydrogen atoms or hydrocarbon groups, in particular alkyl groups, possibly substituted with one or more heteroatoms such as one or more sulphur atoms, the simplest compound of this family being the thiourea of formula (NH₂)₂C═S.

In particular, an organic resin comprising this type of chelating agent may be obtained by impregnating an adsorbent resin, having a crosslinked poly(met)acrylate or polystyrenic matrix, such as the aforementioned resin Amberlite™ XAD4, with the thiourea.

In which case, the thiourea with which the resin is impregnated could in particular be any lipophilic thiourea, such a thiourea being typically a thiourea comprising at least one C8 to C15 alkyl group such as 1-dodecyl-3-methylthiourea, 1,3-dioctylthiourea, 1-(2-(dodecylthio)ethyl)-3-methylthiourea, 1-methyl-3-(2-(nonylthio)ethyl)thiourea, 1-methyl-3-(2-(octylthio)ethyl)thiourea, 1-(2-(dodecylthio)-ethyl)-3-ethylthiourea or 1-(2-(dodecylthio)ethyl)-3-propylthiourea.

Among these thioureas, preference is given to 1-(2-dodecylthio)ethyl)-3-methylthiourea.

If such a chelating organic resin is used, then the additional purification of ruthenium preferably comprises at least the following successive steps:
d) extracting ruthenium from the aqueous solution A5, this extraction comprising contacting, in a chromatography column, the chelating organic resin with the aqueous solution A5, the aqueous solution A5 comprising at most 4 mol/L of nitric or hydrochloric acid and, possibly, from 0.45 mol/L to 4 mol/L of an amine base;
e) washing at least once the chelating organic resin with an aqueous solution A6 comprising at most 4 mol/L of nitric or hydrochloric acid and, possibly, from 0.45 mol/L to 4 mol/L of the amine base; and
f) eluting ruthenium from the chelating organic resin with an aqueous solution A7 comprising from 0.5 mol/L to 2 mol/L of thiourea of formula (NH2) 2C=S and from 0.01 mol/L to 1 mol/L of hydrochloric acid.

It goes without saying that, if in step c) of the process, the elution of ruthenium from the cation-exchange resin is carried out with an aqueous solution A4 of nitric or hydrochloric acid comprising a nitrate or a metal chloride, then the aqueous solution A5, which is subjected to any one of the additional purifications, also comprises this metal nitrate or chloride. In which case, it is possible to use, for the washing of step e) of these purifications, an aqueous solution A6 which comprises, in addition to the nitric or hydrochloric acid and, possibly, the amine base, a metal nitrate or chloride identical to that one present in the aqueous solution A5.

Moreover, if in step c) of the process, the elution of ruthenium from the cation-exchange resin is carried out with an aqueous solution A3 or A4 of nitric or hydrochloric acid with a molarity higher than 4, then the process further comprises, between this step c) and step d) of any one of the additional purifications, a dilution of the aqueous solution A5 to bring its nitric or hydrochloric acid concentration to a value of at most 4 mol/L as well as a possible addition of the amine base to partially reduce its acidity while maintaining a high content of nitrates or chlorides if present.

As known per se, the amine base may consist of any compound comprising one or more nitrogen atom(s) capable of capturing a proton in an aqueous medium like ammonia, guanidine, an alkylamine such as methylamine, dimethylamine, trimethylamine, ethylamine, diethylamine or triethylamine, or a nitrogenated compound such as pyridine, imidazole or histidine, provided that the amine base used is water-soluble.

Among these bases, preference is given to triethylamine.

In accordance with the invention, the aqueous solution A1 is preferably a solution resulting from the dissolution, in nitric acid, of a technetium-99 target having been irradiated with protons and, more specifically, by a nuclear reaction ⁹⁹Tc(p,3n)⁹⁷Ru in the proton energy range of 20 MeV to 100 MeV.

In which case, the aqueous solution A1 comprises ruthenium-97, technetium-97 and, as a metal impurity, molybdenum-97, typically in a mass ratio of technetium to ruthenium ranging from 2×10⁴ to 10⁶, and in a mass ratio of technetium to molybdenum ranging from 4×10⁵ to 2×10⁷.

Another object of the invention is a process for producing ruthenium-97 from a technetium-99 target having been irradiated with protons, which comprises at least the following steps:
i) preparing an aqueous solution A1 of nitric acid comprising ruthenium at a concentration C1, technetium at a concentration C2 at least 10 times higher than C1, and metal impurities by dissolving the target in the nitric acid; and
ii) purifying ruthenium-97 present in the aqueous solution A1 by implementing a purification process as defined before.

Other features and advantages of the invention will become apparent upon reading the following complementary description which relates to examples having allowed experimentally validating the purification process of the invention.

It goes without saying that this complementary description is given only for illustration of the object of the invention and in no way forms a limitation of this object.

### BRIEF DESCRIPTION OF THE FIGURES

FIG. 1 illustrates, in the form of histograms, the extraction yields, denoted R_{EX} and expressed in %, of ruthenium, rhenium (simulating technetium), rhodium and molybdenum as obtained during extraction tests having been carried out by bringing into contact, in centrifugation tubes, aqueous solutions simulating a solution resulting from the dissolution in nitric acid of a technetium target irradiated with a cation-exchange resin; these extraction yields are expressed as a function of the concentration of nitric acid, denoted [HNO₃] and expressed in mol/L, of the aqueous solutions.

FIG. 2 illustrates, in the form of a curve, the evolution of the separation factor between ruthenium and rhenium, denoted FS_{Ru/Re}, as a function of the nitric acid concentration, denoted [HNO₃] and expressed in mol/L, as obtained during extraction tests having been carried out by contacting, in centrifugation tubes, aqueous solutions simulating a solution resulting from the dissolution in nitric acid of a technetium target irradiated with a cation-exchange resin.

FIG. 3 illustrates, in the form of histograms, the extraction yields, denoted R_{EX} and expressed in %, of ruthenium as obtained during extraction tests having been carried out by contacting, in centrifugation tubes, aqueous solutions comprising ruthenium at concentrations ranging from 1 mg/L to 100 g/L of ruthenium and 0.5 mol/L of nitric acid; these extraction yields are expressed as a function of ruthenium concentration of the aqueous solutions, denoted [Ru] and expressed in g/L.

FIG. 4 illustrates, in the form of histograms, the extraction yields, denoted R_{EX} and expressed in %, of ruthenium and rhenium as obtained during extraction tests having been carried out by contacting, in centrifugation tubes, aqueous solutions having a rhenium concentration 10 times, 100 times and 1,000 times higher than their ruthenium concentration and comprising 0.5 mol/L of nitric acid; these extraction yields are expressed as a function of the ratio of the rhenium and ruthenium concentrations, denoted [Re] /[Ru].

FIG. 5 illustrates, in the form of histograms, the elution yields, denoted R_{ELU} and expressed in %, ruthenium, rhenium, rhodium and molybdenum as obtained during elution tests having been carried out by contacting, in centrifugation tubes, different types of elution solutions with cation-exchange resins loaded beforehand with these metal elements.

FIG. 6 illustrates the evolution of the recovery rates, denoted TR and expressed in %, of ruthenium and rhenium as obtained in a test aiming to purify ruthenium from an aqueous solution comprising 1 g/L of rhenium, 0.1 g/L of ruthenium and 0.1 mol/L of nitric acid by means of a column containing a cation-exchange resin; these recovery rates are expressed as a function of the number of bed volumes, denoted BV, used during this test; the arrow f1 indicates the start of washing of the subsequent resin following loading thereof with the aqueous solution whereas the arrow f2 indicates the start of elution of ruthenium from the resin.

FIG. 7 is a figure similar to FIG. 6 but for a ruthenium purification test differing from the previous one only by the nature of the solution used to elute ruthenium from the resin.

### DETAILED DISCLOSURE OF PARTICULAR MODES OF IMPLEMENTATION

In the following:
the extraction yield of a metal element, denoted as R_{EXT} and expressed in %, corresponds to the ratio of the amount of the metal element having been retained by a resin to the amount of this metal element which was present in a solution before passage of this solution over this resin;
the elution yield of a metal element, denoted as R_{ELU} and expressed in %, corresponds to the ratio of the amount of the metal element having been eluted from a resin to the amount of this metal element having been retained beforehand by this resin;
the distribution coefficient of a metal element, denoted as K_{d} and expressed in mL/g, corresponds to the ratio of the concentration of the metal element having been retained by a resin (per gram of dry resin) to the concentration of this metal element having remained in a solution (per millilitre of solution) after passage of this solution over the resin;
the recovery rate of a metal element, denoted as TR and expressed in %, corresponds to the ratio of the amount of the metal element having been eluted from a resin to the amount of this metal element that was present in a solution before passage of this solution over the resin;
the separation factor between two metal elements M1 and M2, denoted as FS_{M1/M2} and unitless, corresponds to the ratio between the distribution coefficients of the two metal elements;
the decontamination factor of a metal element M1 with respect to a metal element M2, denoted as FD_{M1/M2} and unitless, corresponds to the ratio of the ratio of the concentrations of the two metal elements in a solution before purification(s) on the ratio of the concentrations of the two metal elements in the solution after purification(s).

All of the values given hereinafter are expressed with a relative uncertainty of 10% which groups together the different experimental and analytical uncertainties.

Moreover, in the tests that are reported hereinafter, technetium has been replaced, for reasons related to radioprotection of the experimenters, with rhenium, whose behaviour simulates that of technetium, as widely described in the prior art.

### Example 1: Purification of Ruthenium in Batch by Means of a Cation-Exchange Resin

The present example relates to tests for the extraction of ruthenium by a cation-exchange resin and elution of this metal element from this resin, which are all carried out in batch, in centrifugation tubes.

The cation-exchange resin is the resin AG MP-50 from BioRad.

The centrifugation tubes are equipped with an insert with a polytetrafluoroethylene (PTFE) filter with a porosity of 0.2 μm so that the resin is brought into contact with the aqueous solution subjected to the extraction or used for the elution, and then their separation by filtration could be performed in the same tube by simple centrifugation.

### 1.1—Influence of the Nitric Acid Concentration on the Extraction Yield of Ruthenium

A first series of tests is carried out aiming to extract, by the cation-exchange resin, ruthenium from aqueous solutions which all comprise 1 g/L of rhenium, 0.1 g/L of ruthenium, 0.1 g/L of rhodium and 0.1 g/L of molybdenum but differ from one another by their nitric acid concentration which ranges from 0.1 mol/L to 12 mol/L.

These solutions are prepared by dilution of perrhenic acid, HReO₄, of ruthenium nitrosyl nitrate (III), Ru(NO)(NO₃)₃, and of rhodium nitrate (III), Rh(NO₃)₃, in solution and by dissolution of hydrated molybdenum trioxide, MoO₃·H₂O, in nitric acid.

Each test consists in contacting, in one of the centrifugation tubes, 700 μl of one of the aqueous solutions with 100 mg of the wet resin (i.e. about 48 mg of dry resin), stirring the tube (on ThermoMixer™) for 30 minutes at 1,500 rpm at 25° C., and then separating the aqueous solution by centrifugation for 5 minutes at 14,500 rpm.

The aqueous solution thus recovered is analysed by inductively-coupled plasma atomic emission spectrometry (ICP-AES) to determine its concentration of each of the four metal elements remained in solution after extraction.

The material balances are verified by mineralisation of the resin, i.e. digestion in a microwave reactor where it is dissolved in 8 mL of a 1:1 (v/v) HNO₃/H₂O₂ mixture and heated for 1 hour at 200° C. The volume of the solution thus obtained is set again and then also analysed by ICP-AES.

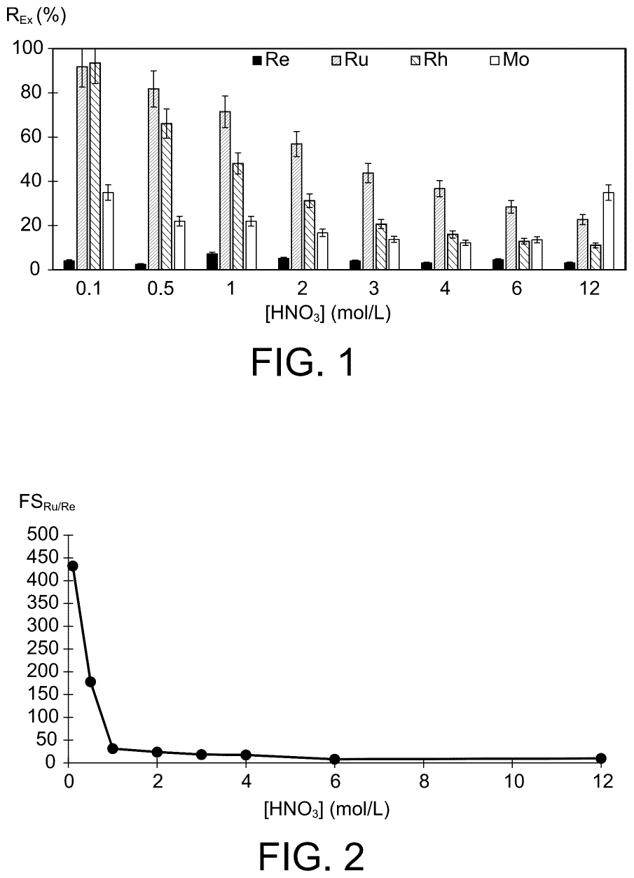

The results are illustrated in FIGS. 1 and 2, respectively in terms of extraction yields, R_{EX}, obtained for the four metal elements and of evolution of the separation factor between ruthenium and rhenium, FS_{Ru/Re}, as a function of the nitric acid concentration of the aqueous solutions before they are brought into contact with the resin.

FIG. 1 shows that, with the type of cation-exchange resin being used, a low concentration of nitric acid favours the extraction of ruthenium whereas rhenium is almost not extracted, irrespective of the nitric acid concentration.

Thus, and as shown in FIG. 2, the best separation factors between ruthenium and rhenium, FS_{Ru/Re}, are obtained for nitric acid concentrations of 0.1 mol/L or 0.5 mol/L.

In particular, for a nitric acid concentration of 0.1 mol/L, the ruthenium extraction yield is higher than 90%, which corresponds to a distribution coefficient of 260 ml/g.

The separation factor FS_{Ru/Re} obtained under these conditions is 432, which reflects a good separation between ruthenium and rhenium.

This separation factor could be further improved by proceeding, upon completion of the extraction, with a washing of the resin by means of an aqueous solution with a low concentration of nitric acid, comprising, for example, from 0.01 mol/L to 0.5 mol/L of nitric acid, preferably 0.1 mol/L (cf. point 1.5 hereinafter).

However, a ruthenium extraction selectivity is not observed with respect to rhodium and molybdenum both of which are also extracted by the cation-exchange resin, the first in amounts comparable to those of ruthenium and the second one to a lesser extent.

### 1.2—Influence of the Ruthenium Concentration on the Extraction Yield of This Metal Element

A second series of tests is carried out in order to assess the influence of the concentration of ruthenium in the aqueous solution from which it is to be extracted on its extraction yield by the cation exchange resin.

These tests are carried out according to an operating protocol similar to that one described in point 1.1 hereinbefore but using aqueous solutions comprising from 1 mg/L to 100 g/L of ruthenium (supplied in the form of Ru(NO)(NO₃)₃) and 0.5 mol/L of nitric acid.

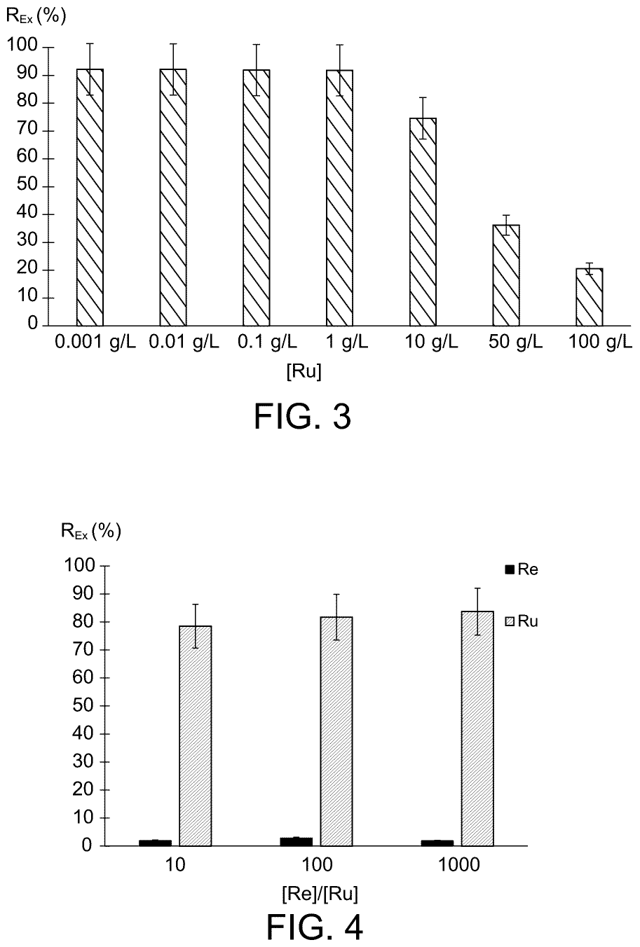

The extraction yields, R_{EX}, of ruthenium thus obtained are illustrated in FIG. 3.

As shown in this figure, the ruthenium extraction yield is constant and higher than 90% for ruthenium concentrations lower than or equal to 1 g/L.

The obtained isotherm follows the Langmuir model, characteristic of a monolayer and homogeneous adsorption of ruthenium on the surface of the particles of the resin.

### 1.3—Influence of the Re/Ru Concentration Ratio on the Extraction Yield of Ruthenium

A third series of tests is carried out in order to assess the influence of the rhenium-to-ruthenium concentration ratio in an aqueous solution, from which ruthenium is to be extracted, on its extraction yield by the cation exchange resin

These tests are carried out according to an operating protocol similar to that one described in point 1.1 hereinbefore but using aqueous solutions having a rhenium concentration (supplied in the form of HReO₄) 10 times, 100 times and 1,000 times higher than their ruthenium concentration (supplied in the form of Ru (NO)(NO₃)₃) and comprising 0.5 mol/L of nitric acid.

The extraction yields, R_{EX}, of ruthenium thus obtained are illustrated in FIG. 4.

As shown in this figure, the ratio of rhenium and ruthenium concentrations has little influence on the extraction yield of ruthenium, which remains almost constant independently of the excess rhenium present in solution.

These results are of particular interest for an application of the process of the invention to the purification of ruthenium produced by the irradiation of a technetium target because, in this case, the concentration of technetium in the solution resulting from the dissolution of the target in nitric acid could range up to 100,000 times that of ruthenium.

### 1.4—Elution of Ruthenium From the Cation-Exchange Resin

After having carried out a series of extractions as described in point 1.1 hereinbefore, from aqueous solutions comprising 1 g/L of rhenium, 0.1 g/L of ruthenium, 0.1 g/L of rhodium, 0.1 g/L of molybdenum and 0.1 mol/L or 0.5 mol/L of nitric acid, the resins thus loaded with metal elements (Ru, Rh, Mo and traces of Re as illustrated in FIG. 1) are subjected to elution.

To do so, 700 μL of an elution solution are added to the centrifugation tubes in which the resins loaded with metal elements are located for contact under the same operating conditions as those described in point 1.1 hereinbefore (30 minutes, 1,500 rpm, 25° C.), then the elution solutions are separated by centrifugation for 5 minutes at 14,500 rpm.

The elution solutions and the resins thus separated are analysed by ICP-AES (after mineralisation of the resins as described in point 1.1 hereinbefore).

The tested elution solutions are:
aqueous solutions comprising from 0.01 mol/L to 12 mol/L of nitric acid or from 0.01 mol/L to 6 mol/L of hydrochloric acid for the extractions having been carried out from aqueous solutions comprising 0.1 mol/L of nitric acid, and
aqueous solutions comprising 2.12 mol/L of magnesium nitrate, Mg(NO₃)₂, or calcium, Ca(NO₃)₂, and 0.01 mol/L of nitric acid for the extractions having been carried out from aqueous solutions comprising 0.5 mol/L of nitric acid.

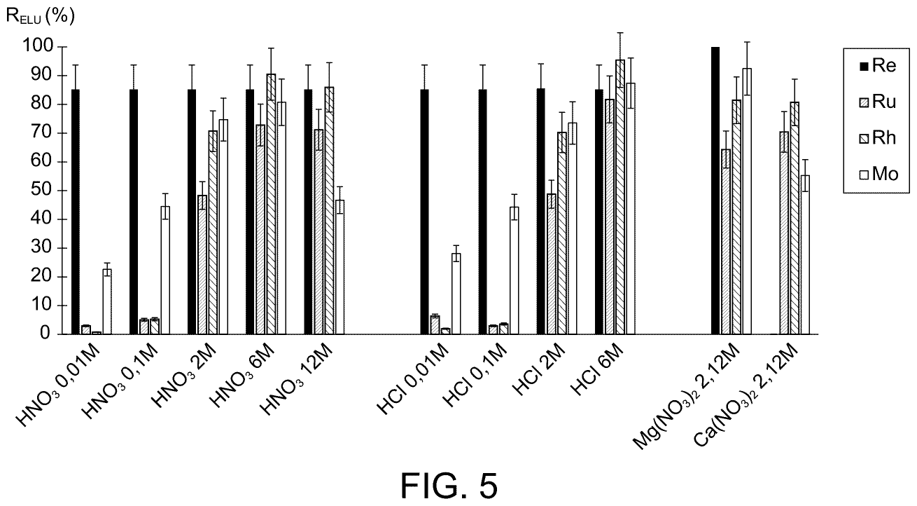

The elution yields, R_{ELU}, thus obtained are illustrated in FIG. 5.

This figure shows that the use of a highly concentrated aqueous solution of nitric or hydrochloric acid (at 6 mol/L or more of HNO₃ or HCl) as an elution solution leads to a very satisfactory recovery of ruthenium (70% to 80% ruthenium extracted beforehand) but without being selective with respect to rhodium and molybdenum.

It shows that the use of an aqueous solution of a metal nitrate as an elution solution also leads to a good recovery of ruthenium (64% and 70% of ruthenium extracted beforehand for magnesium nitrate and nitrate calcium, respectively) but, herein again, without any selectivity with respect to rhodium and molybdenum.

On the other hand, the use of a weakly concentrated aqueous solution of nitric or hydrochloric acid (at 0.01 mol/L or 0.1 mol/L of HNO₃ or HCl, for example) leads to a quantitative recovery of rhenium extracted beforehand (>85% but difficult to assay due to the very small amount of rhenium extracted beforehand and therefore eluted afterwards) and a portion of the molybdenum (up to 45% of the molybdenum having been extracted beforehand) while limiting leakage of ruthenium from the resin (with a maximum of 5% of eluted ruthenium). Hence, such a weakly concentrated solution of nitric or hydrochloric acid may be used to wash the cation-exchange resin in order to remove residual traces of technetium therefrom (simulated herein by rhenium) as well as most of molybdenum having been extracted beforehand before eluting ruthenium from the resin.

### 1.5—Simulation of a Purification of Ruthenium From a Solution Resulting From the Dissolution of a Technetium Target Irradiated With Protons

A test is carried out under conditions, in particular with regards to the composition of the aqueous solution from which ruthenium should be purified as well as the sequence of the steps, close to those of an implementation of the process of the invention for the purification of ruthenium from a solution resulting from the dissolution in nitric acid of a technetium target that has been irradiated with protons.

Therefore, in this test, it is proceeded with a step of extracting ruthenium by the cation-exchange resin, a step of washing this resin and a step of eluting ruthenium from said resin.

The ruthenium extraction step is carried out by bringing 700 μl of an aqueous solution comprising 10 g/L of rhenium (supplied in the form of HReO₄), 1 g/L of ruthenium (supplied in the form of Ru(NO)(NO₃)₃), 40 mg/L of molybdenum (supplied in the form of MoO₃·H₂O) and 0.1 mol/L of nitric acid into contact with 100 mg of the resin, while stirring the tube for 30 minutes at 1,500 rpm at 25° C., and then separating the solution by centrifugation for 5 minutes at 14,500 rpm.

The step of washing the resin is carried out by placing, twice successively, 700 μl of an aqueous solution comprising 0.1 mol/L of nitric acid into contact with the resin with, for each contact, stirring of the tube for 5 minutes at 1,500 rpm at 25° C., and then by separating, upon completion of each contact, the washing solution by centrifugation for 5 minutes at 14,500 rpm.

As regards the ruthenium elution step, it is carried out by bringing 700 μl of a solution comprising 500 g/L of calcium nitrate and 0.01 mol/L of nitric acid into contact with the resin, while stirring the tube for 30 minutes at 1,500 rpm at 25° C., and then by filtering the elution solution by centrifugation for 5 minutes at 14,500 rpm.

All of the solutions resulting from the filtrations are assayed by ICP-AES.

The solution obtained upon completion of the elution comprises 527 mg/L of ruthenium, 0.3 mg/L of rhenium and 0.96 mg/L of molybdenum, which corresponds to:
a distribution coefficient Kd of ruthenium of 578 mL/g,
decontamination factors FD_{Ru/Re} of 16,870 and FD_{Ru/Mo} of 23, and
recovery of 50% of the amount of ruthenium present in the starting aqueous solution for a final purity of ruthenium of 99.76% in one single contact step.

### Example 2: Purification of Ruthenium Continuously by Means of a Cation-Exchange Resin

The present example relates to two tests aiming to purify ruthenium by means of a cation-exchange resin and which are carried out continuously, in a chromatography column. The two tests differ from one another only by the solution used to elute ruthenium from the resin.

The cation-exchange resin is the resin AG MP-50 from BioRad.

The column is a glass column with a diameter of 1 cm and a height of 15 cm, with a double jacket which is connected to a thermostatically-controlled bath. It is equipped with two sintered glasses, one of which is located at its base and the other is added above the resin after filling of the column with the latter. It is also equipped with a tank and a tap, respectively at the top and at the bottom of the column.

The column is prepared by introducing at the top of the column an aqueous suspension comprising 5 g of resin in nitric acid at 0.1 mol/L. Once compacted by gravity, the resin bed is deposited over a height of 10 cm, which corresponds to a column volume, or bed volume, more simply so-called BV (standing for Bed volume), of 7.85 mL.

Then, the resin is conditioned by washing with a few ml of an aqueous solution comprising 0.1 mol/L of nitric acid.

Once the column is ready, 50 mL of an aqueous solution comprising 1 g/L of rhenium (supplied in the form of HReO₄), 0.1 g/L of ruthenium (supplied in the form of Ru(NO)(NO₃)₃) and 0.1 mol/L of nitric acid are introduced at the top of the column. The aqueous solution is allowed to flow from the column by gravity at room temperature. Once this solution has been recovered at the bottom of the column, its volume is set again into a 50 mL graduated flask and analysed by ICP-AES to determine its content at each of the two metal elements.

Afterwards, the resin is washed with 50 ml of an aqueous solution comprising 0.1 mol/L of nitric acid which is, in turn, allowed to flow by gravity and which is recovered afterwards at the bottom of the column and analysed by ICP-AES.

Then, the column is heated to 60° C. by circulating water in the double jacket and 20 ml of an elution solution, preheated to 60° C., are introduced into the column.

For the first test, the elution solution is an aqueous solution which comprises 6 mol/L of nitric acid whereas, for the second one, the elution solution is an aqueous solution which comprises either 2.12 mol/L of magnesium nitrate and 0.01 mol/L of nitric acid.

In both cases, after elution of a column volume (i.e. 7.85 mL), the flow of the elution solution is stopped for one hour, and then the remainder of the elution solution is allowed to flow. The volume of all of the elution solution recovered at the bottom of the column is set again into a 25 mL graduated flask and then analysed by ICP-AES.

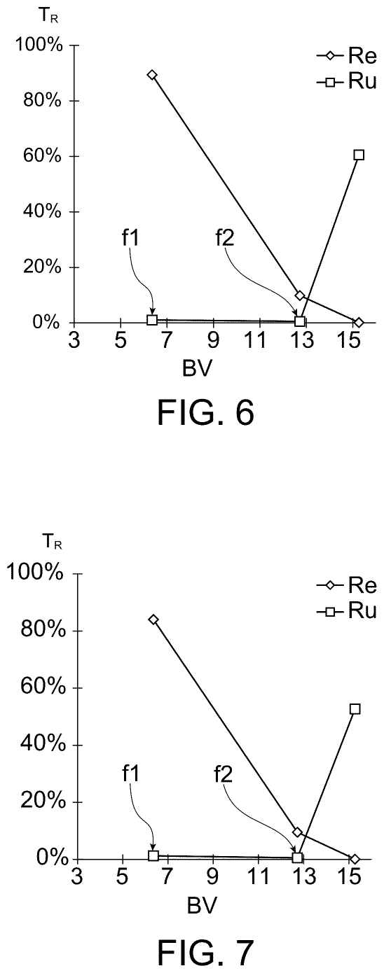

FIGS. 6 and 7 illustrate the evolution of the recovery rates, denoted TR and expressed in %, of ruthenium and rhenium, thus obtained as a function of the number of used bed volumes, denoted BV, FIG. 6 corresponding to the first test and FIG. 7 corresponding to the second one.

In these figures, the arrow f1 indicates the start of washing of the resin following loading thereof with the aqueous solution comprising rhenium and ruthenium whereas the arrow f2 indicates the start of elution of ruthenium.

These figures show that the recovery of ruthenium upon completion of elution thereof from the resin is very satisfactory for both tests with recovery rates of 61% and 53% respectively.

The purification of ruthenium with respect to rhenium (and, therefore, technetium) is also very satisfactory for both tests with FD_{Ru/Re} of 418 and 808 respectively.

### Example 3: Additional Purification of Ruthenium by Means of a Chelating Organic Resin

### 3.1—Purification of Ruthenium in Batch by Means of a Chelating Organic Resin Comprising a Bipyridine or a Phenanthroline

Tests aiming to assess the possibility of perfecting the purification of ruthenium having been subjected beforehand to a purification by means of a cation-exchange resin are carried out using a chelating organic resin comprising a bipyridine or a phenanthroline.

Bipyridine is 4,4′-dinonyl-2,2′-bipyridine, whereas phenanthroline is bathophenanthroline, these two compounds being available from Sigma-Aldrich.

The resin comprising bipyridine—hereinafter so-called DNPB—and the resin comprising phenanthroline—hereinafter so-called BPhen—are prepared beforehand by impregnating the adsorbent resin Amberlite™ XAD4 (DuPont) with 4,4′-dinonyl-2,2′-bipyridine for the first one and bathophenanthroline for the second one, in a ratio of about 1.15 mmol/g of dry resin.

To do so, the adsorbent resin is firstly washed with water and then with ethanol, and then dried for a few hours. Then, 500 mg of dry resin are mixed in a round-bottomed flask with 0.573 mmol of 4,4′-dinonyl-2,2′-bipyridine (i.e. 234 mg) or bathophenanthroline (i.e. 191 mg) and 15 ml of dichloromethane. The mixture is stirred overnight and then the solvent is evaporated slowly with a rotary evaporator. Just before the end of the evaporation, 10 mL of dichloromethane are added into the medium and evaporated in the same manner until drying. Afterwards, the resins DNPB and BPhen thus obtained are placed overnight in a desiccator under high vacuum to remove any trace of solvent.

Prior to the tests, the resins are conditioned by contact for 1 hour with an aqueous solution comprising 2 mol/L of nitric acid and 1.95 mol/L of triethylamine.

The tests are carried out with an aqueous solution comprising 10 mg/L of ruthenium (supplied in the form of Ru(NO)(NO₃)₃), 10 mg/L of rhenium (supplied in the form of perrhenic acid), 10 mg/L of molybdenum (supplied in the form of MoO₃·H₂O) and 2 mol/L of nitric acid.

Each test comprises an extraction of ruthenium from the aqueous solution by one of the resins DNPB and BPhen followed by an elution of ruthenium from this resin.

The extraction of ruthenium consists in bringing into contact, in an insert centrifugation tube as described in Example 1 hereinbefore, 700 μL of the aqueous solution with 50 mg of one of the resins, while stirring the tube (on ThermoMixer™) for 24 hours at 1,500 rpm, and then separating the aqueous solution by centrifugation for 5 minutes at 14,500 rpm.

The elution of ruthenium is carried out by bringing 700 μl of an aqueous solution comprising 10 mol/L of hydrochloric acid into contact with the resin, while stirring the tube for 24 hours at 1,500 rpm at 25° C., and then by filtering the elution solution by centrifugation for 5 minutes at 14,500 rpm.

All of the solutions resulting from the filtrations are analysed by ICP-AES.

These analyses show that, under these conditions, the two resins lead to similar results. Indeed, irrespective of the resin being tested, only ruthenium and molybdenum are extracted by this resin, rhodium remaining in solution during the extraction. The ruthenium extraction yield is very satisfactory since it is 60% for one single solution/resin contact.

Afterwards, the elution with 10 mol/L hydrochloric acid allows recovering ruthenium selectively from molybdenum which, in turn, remains fixed on the resins.

Thus, decontamination factors FD_{Ru/Mo} of 20 and 40 respectively for the resins DNPB and BPhen and a decontamination factor FD_{Ru/Rh} of about 30 for the two resins are obtained.

It should however be noted that the fact that the tests are carried out in batch conjugated with the absence of intermediate washing of the resin results in considerably reducing the decontamination factors with respect to those which would be obtained in a chromatography column and with an intermediate washing of the resin in accordance with the process of the invention.

Hence, in view of these results, it is possible to perfect the purification of ruthenium by means of a chelating organic resin comprising a bipyridine or a phenanthroline.

### 3.2—Purification of Ruthenium in Batch by Means of a Chelating Organic Resin Comprising a Thiourea

A test similar to that one which has just been described is carried out to verify the possibility of perfecting the purification of ruthenium having been subjected beforehand to a purification by means of a cation-exchange resin using a chelating organic resin comprising a thiourea, hereinafter so-called MTU.

Thiourea is 1-(2-(dodecylthio) ethyl)-3-methylthiourea. It is synthesised beforehand from 2-(dodecylthio) ethan-1-amine (1 eq) and methylisothiocyanate (1.1 eq). To do so, the two reagents are mixed for 5 hours at 45° C. in dichloromethane, and then the solvent is evaporated under reduced pressure and the product is purified on a silica column by a heptane/ethyl acetate gradient. A yield of 74% is obtained for this synthesis. The purity of the product is assayed by proton nuclear magnetic resonance (NMR) spectroscopy.

The resin MTU is prepared by impregnating the adsorbent resin Amberlite™ XAD4 with 1-(2-(dodecylthio)ethyl)-3-methylthiourea in the same manner as for the preparation of the resins BNPB and BPhen, except that the impregnation is carried out on 1 g of dry resin with 1.146 mmol of methylthiourea (i.e. 281 mg).

The test is carried out with an aqueous solution comprising 10 mg/L of ruthenium (supplied in the form of Ru(NO)(NO₃)₃), 10 mg/L of rhenium (supplied in the form of perrhenic acid), 10 mg/L of molybdenum (supplied in the form of MoO₃·H₂O) and 2 mol/L of nitric acid.

It comprises an extraction of ruthenium from the aqueous solution by the resin MTU followed by a step of eluting ruthenium from this resin.

This extraction and this elution are carried out according to an operating protocol identical to that one described in point 3.1 hereinbefore except that ruthenium is eluted with an aqueous solution comprising 0.5 mol/L of thiourea of formula NH₂)₂C═S and 0.01 mol/L of hydrochloric acid.

All of the solutions resulting from the filtrations are analysed by ICP-AES.

These analyses show that, under these conditions, ruthenium is extracted by the resin MTU whereas rhodium is not extract at all and molybdenum is extracted only very slightly.

They also show that the elution of ruthenium with the aqueous solution of thiourea/HCl is not very selective with respect to molybdenum. Nonetheless, this low selectivity is not detrimental since molybdenum is extracted only very slightly by the resin MTU.

The additional purification of ruthenium with respect to molybdenum carried out by means of the resin MTU is fully satisfactory since the obtained separation factor FD_{Ru/Mo} is 10 while, herein again, the test has not been carried out under the most favourable conditions (batch test and absence of intermediate washing of the resin).

### Example 4: Simulation of a Ruthenium Purification From a Solution Resulting From the Dissolution of a Technetium Target Irradiated With Protons Implementing a Cation-Exchange Resin and a Chelating Organic Resin Comprising a Diglycolamide

The present example relates to two tests aiming to purify ruthenium a first time by means of a cation-exchange resin and a second time by means of a chelating organic resin comprising a diglycolamide.

These tests are carried out in batch in centrifugation tubes as described in point 1 hereinbefore and differ from one another only by the solution used to elute ruthenium from the chelating organic resin.

The cation-exchange resin is the resin AG MP-50 from BioRad.

The chelating organic resin is the resin DGA N (100-150 μm) from Triskem.

The operating protocol is as follows.

### * Purification by Means the Cation-Exchange Resin:

Extraction of ruthenium by contacting 700 μl of an aqueous solution comprising 9 g/L of rhenium, 0.9 g/L of ruthenium, 38 mg/L of molybdenum and 0.1 mol/L of nitric acid with 100 mg of the cation-exchange resin in a centrifugation tube, stirring of the tube for 30 minutes at 1,500 rpm at 25° C., and solid/liquid separation by centrifugation for 5 minutes at 14,500 rpm;
Washings of the resin: 2 in number, each by contacting 700 μL of an aqueous solution comprising 0.1 mol/L of nitric acid with the resin, stirring of the tube for 5 minutes at 25° C. and 1,500 rpm, and solid/liquid separation by centrifugation for 5 minutes at 14,500 rpm;
Elution of ruthenium by contacting 700 μl of an aqueous solution comprising 2.12 mol/L of magnesium nitrate and 0.01 mol/L of nitric acid with the resin, stirring of the tube for 30 minutes at 1,500 rpm at 25° C., and solid/liquid separation by centrifugation for 5 minutes at 14,500 rpm.

### * Purification by Means of the Chelating Organic Resin:

Extraction of ruthenium by contacting the 700 μl of the aqueous solution obtained upon completion of the elution hereinbefore with 50 mg of the chelating resin (balanced beforehand with an aqueous solution of magnesium nitrate) in a centrifugation tube, stirring of the tube for 24 hours at 1,500 rpm at 25° C., and solid/liquid separation by centrifugation for 5 minutes at 14,500 rpm;
Washing of the resin by contacting 700 μl of an aqueous solution comprising 2.12 mol/L of magnesium nitrate and 0.01 mol/L of nitric acid with the resin, stirring of the tube for 5 minutes at 1,500 rpm at 25° C., and solid/liquid separation by centrifugation for 5 minutes at 14,500 rpm;
Elution of ruthenium by contacting 700 μL of an aqueous solution comprising 10 mol/L of hydrochloric acid for the first test and 10 mol/L of nitric acid for the second one with the resin, stirring of the tube for 24 hours at 1,500 rpm at 25° C., and solid/liquid separation by centrifugation for 5 minutes at 14,500 rpm.

All of the solutions resulting from the filtrations are assayed by ICP-AES.

These analyses show that it is possible to perfect the purification of ruthenium by means of a chelating organic resin comprising a diglycolamide such as the TODGA.

Indeed, in the case of elution of ruthenium from the chelating organic resin with the 10 M aqueous solution of hydrochloric acid, a final purity of ruthenium of 99.84% is obtained with ruthenium decontamination factors with respect to rhenium (and therefore technetium) and molybdenum initially present in the aqueous solution having been subjected to the two successive purifications of 9,550 and 85 respectively.

The elution of ruthenium from the chelating organic resin with the 10 M aqueous solution of nitric acid leads to even more interesting results since a final purity of ruthenium of 99.89% is obtained with decontamination factors of ruthenium with respect to rhenium (and therefore technetium) and molybdenum initially present in the aqueous solution having been subjected to the two successive purifications of 14,205 and 118 respectively.

### CITED REFERENCES

[1] N. G. Zaitseva et al., Radiochimica Acta 1992, 56, 59-68
[2] N. G. Zaitseva et al., Applied Radiation and Isotopes 1996, 47 (2), 145-151
[3] EP-A-0 347 625

What is claimed is:

1. A process for purifying ruthenium from an aqueous solution A1 of nitric acid comprising, in addition to the ruthenium at a concentration C1, technetium at a concentration C2 at least 10 times higher than C1, and metallic impurities, which comprises at least the following successive steps:
a) extracting the ruthenium from the aqueous solution A1 by means of a cation-exchange resin which retains the ruthenium selectively with respect to the technetium when ruthenium and technetium are in an aqueous solution of nitric acid with a molarity comprised between a first value M1 and a second value M2 higher than M1, the extraction comprising contacting, in a chromatography column, the cation-exchange resin with the aqueous solution A1, the molarity of the aqueous solution A1 being comprised between M1 and M2;
b) washing at least once the cation-exchange resin with an aqueous solution A2 of nitric acid with a molarity comprised between M1 and M2; and
c) eluting the ruthenium from the cation-exchange resin with an aqueous solution A3 of nitric or hydrochloric acid with a molarity higher than M2 or an aqueous solution A4 of nitric or hydrochloric acid with a molarity at most equal to M2 and comprising a metal nitrate or chloride, whereby an aqueous solution A5 containing the ruthenium is obtained.

2. The process of claim 1, further comprising, prior to step a), adjusting the molarity of the aqueous solution A1 to a molarity comprised between M1 and M2.

3. The process of claim 1, wherein the cation-exchange resin is a porous resin with a crosslinked poly(meth)acrylate or polystyrenic matrix which is functionalised by sulphonic acid groups.

4. The process of claim 1, wherein the aqueous solutions A1 and A2 comprise from 0.01 mol/L to 0.5 mol/L of nitric acid.

5. The process of claim 1, wherein the aqueous solution A3 comprises at least 2 mol/L of nitric or hydrochloric acid.

6. The process of claim 1, wherein the aqueous solution A4 comprises from 0.01 mol/L to 0.5 mol/L of nitric or hydrochloric acid and at least 1 mol/L of the metal nitrate or chloride.

7. The process of claim 1, further comprising an additional purification of ruthenium present in the aqueous solution A5 by means of a chelating organic resin.

8. The process of claim 7, wherein the chelating organic resin comprises a diglycolamide, a bipyridine, a phenanthroline or a thiourea as a chelating agent.

9. The process of claim 8, wherein the chelating organic resin is made of a crosslinked poly(meth)acrylate or polystyrenic matrix which is impregnated with a diglycolamide, a bipyridine or a phenanthroline.

10. The process of claim 9, wherein the additional purification comprises at least the following successive steps:
d) extracting the ruthenium from the aqueous solution A5, the extraction comprising contacting, in a chromatography column, the chelating organic resin with the aqueous solution A5, the aqueous solution A5 comprising at most 4 mol/L of nitric or hydrochloric acid;
e) washing at least once the chelating organic resin with an aqueous solution A6 comprising at most 4 mol/L of nitric or hydrochloric acid; and
f) eluting the ruthenium from the chelating organic resin with an aqueous solution A7 comprising at least 0.01 mol/L of nitric or hydrochloric acid.

11. The process of claim 8, wherein the chelating organic resin is made of a crosslinked poly(meth)acrylate or polystyrenic matrix which is impregnated with a thiourea.

12. The process of claim 11, wherein the additional purification comprises at least the following successive steps:
d) extracting the ruthenium from the aqueous solution A5, the extraction comprising contacting, in a chromatography column, the chelating organic resin with the aqueous solution A5, the aqueous solution A5 comprising at most 4 mol/L of nitric or hydrochloric acid;
e) washing at least once the chelating organic resin with an aqueous solution A6 comprising at most 4 mol/L of nitric or hydrochloric acid; and
f) eluting the ruthenium from the chelating organic resin with an aqueous solution A7 comprising from 0.5 mol/L to 2 mol/L of thiourea of formula (NH₂)₂C═S and from 0.01 mol/L to 1 mol/L of hydrochloric acid.

13. The process of claim 10, further comprising, between steps c) and d), diluting the aqueous solution A5 to a concentration of at most 4 mol/L of nitric or hydrochloric acid.

14. The process of claim 1, wherein the aqueous solution A1 is a solution resulting from the dissolution, in nitric acid, of a technetium-99 target having been irradiated with protons.

15. The process according to claim 14, wherein the aqueous solution A1 comprises ruthenium-97, technetium-97 and, as a metal impurity, molybdenum-97.

16. A process for producing ruthenium-97 from a technetium-99 target having been irradiated with protons, comprising at least the following successive steps:
preparing an aqueous solution A1 of nitric acid comprising ruthenium-97 at a concentration C1, technetium at a concentration C2 at least 10 times higher than C1, and metal impurities by dissolving the target in the nitric acid;
purifying the ruthenium-97 present in the aqueous solution A1, the purification comprising the following successive steps:
a) extracting the ruthenium-97 from the aqueous solution A1 by means of a cation-exchange resin which retains the ruthenium selectively with respect to the technetium when ruthenium and technetium are in an aqueous solution of nitric acid with a molarity comprised between a first value M1 and a second value M2 higher than M1, the extraction comprising contacting, in a chromatography column, the cation-exchange resin with the aqueous solution A1, the molarity of the aqueous solution A1 being comprised between M1 and M2;
b) washing at least once the cation-exchange resin with an aqueous solution A2 of nitric acid with a molarity comprised between M1 and M2; and
c) eluting the ruthenium-97 from the cation-exchange resin with an aqueous solution A3 of nitric or hydrochloric acid with a molarity higher than M2 or an aqueous solution A4 of nitric or hydrochloric acid with a molarity at most equal to M2 and comprising a metal nitrate or chloride, whereby an aqueous solution A5 containing the ruthenium-97 is obtained.

17. The process of claim 10, wherein the aqueous solutions A5 and A6 further comprise from 0.45 mol/L to 4 mol/L of an amine base.

18. The process of claim 12, wherein the aqueous solutions A5 and A6 further comprise from 0.45 mol/L to 4 mol/L of an amine base.

19. The process of claim 12, further comprising, between steps c) and d), diluting the aqueous solution A5 to a concentration of at most 4 mol/L of nitric or hydrochloric acid.

20. The process of claim 14, wherein the target has been irradiated by a nuclear reaction ⁹⁹Tc(p,3n)⁹⁷Ru in the proton energy range of 20 MeV to 100 MeV.
